(19) United States
(12) Patent Application Publication
(10) Pub. No.: US 2009/0169080 A1
(43) Pub. Date: Jul. 2, 2009

(54) SYSTEM AND METHOD FOR SPATIALLY ENHANCING STRUCTURES IN NOISY IMAGES WITH BLIND DE-CONVOLUTION

(75) Inventor: Niels Noordhoek, Breda (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,056

(22) PCT Filed: Jul. 14, 2006
(86) PCT No.: PCT/IB2006/052414

§ 371 Date: Feb. 6, 2008

Related U.S. Application Data
(60) Provisional application No. 60/706,796, filed on Aug. 9, 2005.

(51) Int. Cl. G06K 9/00; G06K 9/40

(52) U.S. Cl. 382/131; 382/255

(57) ABSTRACT

A method for enhancing objects of interest in a sequence of noisy images (11), the method comprising: acquiring the sequence of images (11); extracting features (61), (62), (71), (72) related to an object of interest on a background in images of the sequence (11) having an image reference; computing a motion vector corresponding to motion of the object of interest associated with at least two images of the sequence (11); deblurring each image of the sequence based on its corresponding motion vector to form a deblurred sequence of images (13); registering the features related to the object of interest in the deblurred sequence of images with respect to the image reference, yielding a registered sequence of images (15); and integrating with a temporal integration both the object of interest and the background over at least two registered images of the registered sequence of images (15).

The present disclosure is directed to a methodology and system for compensating motion in two-dimensional (2D) image projections and three-dimensional (3D) and 4D (3D with cardiac phase) image reconstructions. Particularly motion compensation and augmentation of imaged generated with X-ray fluoroscopy and the like. The disclosed invention finds for example, its application in the medical field of cardiology, for enhancing thin objects of interest such as stents and vessel walls in angiograms.

In X-ray guided cardiac interventions, as e.g. for electro physiology interventions, 3D and 4D reconstructions from X-ray projections of a target ventricular structure are often utilized in order to plan and guide the intervention. The images are acquired, in this example, as a sequence of images during a stent implantation, which is a medical intervention performed under fluoroscopy, and which usually comprises several steps for enlarging an artery at the location of a lesion called a stenosis. Fluoroscopy is a low dose X-ray technique that yields very noisy and low contrasted images. As will be readily appreciated, introducing a catheter in a patient's artery is a delicate procedure where it is highly desirable to provide a clinician, real time imagery of the intervention. Motion blur and motion based artifacts introduced during the intervention further exacerbate the difficulties encountered by the clinician.

A stent is a surgical stainless steel coil that is placed in the artery in order to improve blood circulation in regions where a stenosis has appeared. When a narrowing called stenosis is identified in a coronary artery of a patient, a procedure called angioplasty may be prescribed to improve blood flow to the heart muscle by opening the blockage. In recent years, angioplasty increasingly employs a stent implantation technique. This stent implantation technique includes an operation of stent placement at the location of the detected stenosis in order to efficiently hold open the diseased vessel. The stent is wrapped tightly around a balloon attached to a monorail introduced by way of a catheter and a guide-wire. Once in place, the balloon is inflated in order to expand the coil. Once expanded, the stent, which can be considered as a permanent implant, acts like a scaffold keeping the artery wall open. The artery, the balloon, the stent, the monorail and the thin guide-wire are observed in noisy fluoroscopic images.

Unfortunately, these objects show low radiographic contrast that makes evaluation of the placement and expansion of the stents at an accurate location very difficult. Also, during the operation of stent implantation, the monorail, with the balloon and stent wrapped around it, is moving with respect to the artery, the artery is moving under the influence of the cardiac pulses, and the artery is seen on a background that is moving under the influence of the patient's breathing. These movements make the following of stent implantation under fluoroscopic imaging still more difficult to visualize. In particular, these movements make zooming inefficient because the object of interest may move out of the zoomed image frame. An additional drawback of the current art for imaging is that it is necessary to use a contrast agent in a product introduced in the balloon for inflating the balloon in the operation of stent deployment. The use of the contrast agent prevents the clinician from distinguishing the stent from the balloon and from the wall of the artery.

Furthermore, patient motion during any kind of imaging leads to inconsistent data and hence to artifacts such as blurring and ghost images. Therefore, patient motion has to be avoided or compensated. Practically, avoiding motion, e.g., fixation of the patient is generally difficult or impossible. Thus compensation of/for patient motion is most practicable. The majority of motion compensation methods focuses on how to obtain consistent projection data that all belong to the same motion state and then use this sub-set of projection data for reconstruction. Using multiples of such sub-sets, different motion states of the measured object can be reconstructed. For example, one method employed parallel re-binning cone-beam backprojection to compensate for object motion and time evolution of the X-ray attenuation. A motion field is estimated by block matching of sliding window reconstructions, and consistent data for a voxel under consideration is approximated for every projection angle by linear regression from temporally adjacent projection data from the same direction. The filtered projection data for the voxel is chosen according to the motion vector field. Other methods address motion effects in image reconstructions using a precomputed motion vector field to modify the projection operator and calculate a motion-compensated reconstruction.

Despite efforts to date, a need remains for an effective and cost effective methodology to generate a 3D/4D data set with compensation for motion blur. Combined with the likelihood that future generations of detectors will exhibit even higher resolutions, correction for this motion blur becomes even more desirable.

Disclosed herein in an exemplary embodiment is a method for enhancing objects of interest in a sequence of noisy images, the method comprising: acquiring the sequence of images; extracting features related to an object of interest on a background in images of the sequence having an image reference; computing a motion vector corresponding to motion of the object of interest associated with at least two images of the sequence; deblurring each image of the sequence based on its corresponding motion vector to form a deblurred sequence of images; registering the features related to the object of interest in the deblurred sequence of images with respect to the image reference, yielding a registered sequence of images; and integrating with a temporal integration both the object of interest and the background over at least two registered images of the registered sequence of images.

Also disclosed herein in an exemplary method for enhancing objects of interest in a sequence of noisy images, the method comprising: acquiring the sequence of images; extracting features related to an object of interest on a background in images of the sequence having an image reference; computing a motion vector corresponding to motion of the object of interest associated with at least two images of the sequence; and deblurring each image of the sequence based on its corresponding motion vector to form a deblurred sequence of images.

Further disclosed herein in another exemplary embodiment is a system for enhancing objects of interest in a sequence of noisy images. The system includes: an imaging system for acquiring the sequence of images; a plurality of markers placed in proximity to an object of interest, the markers discernible in the sequence of images; a processor in operable communication with the imaging system, the processor configured to: compute a motion vector corresponding to motion of the object of interest associated with at least two images of the sequence; deblur each image of the sequence based on its corresponding motion vector to form a deblurred sequence of images; register the features related to the object of interest in the deblurred sequence of images with respect to the image reference, yielding a registered sequence of images; and integrate with a temporal integration both the object of interest and the background over at least two registered images of the registered sequence of images.

Disclosed herein in yet another exemplary embodiment is a medical examination imaging apparatus for enhancing objects of interest in a sequence of noisy images. The apparatus comprising: means for acquiring the sequence of images; means for extracting features related to an object of interest on a background in images of the sequence having an image reference; means for computing a motion vector corresponding to motion of the object of interest associated with at least two images of the sequence; means for deblurring each image of the sequence based on its corresponding motion vector to form a deblurred sequence of images; means for registering the features related to the object of interest in the deblurred sequence of images with respect to the image reference, yielding a registered sequence of images; and means for integrating with a temporal integration both the object of interest and the background over at least two registered images of the registered sequence of images.

Also disclosed herein in yet another exemplary embodiment is a storage medium encoded with a machine readable computer program code, the code including instructions for causing a computer to implement either of the abovementioned methods for enhancing objects of interest in a sequence of noisy images.

In yet another exemplary embodiment, there is disclosed herein a computer data signal, the computer data signal comprising instructions for causing a computer to implement either of the abovementioned methods for enhancing objects of interest in a sequence of noisy images.

Additional features, functions and advantages associated with the disclosed methodology will be apparent from the detailed description which follows, particularly when reviewed in conjunction with the figures appended hereto.

To assist those of ordinary skill in the art in making and using the disclosed embodiments, reference is made to the appended figures, wherein like references are numbered alike:

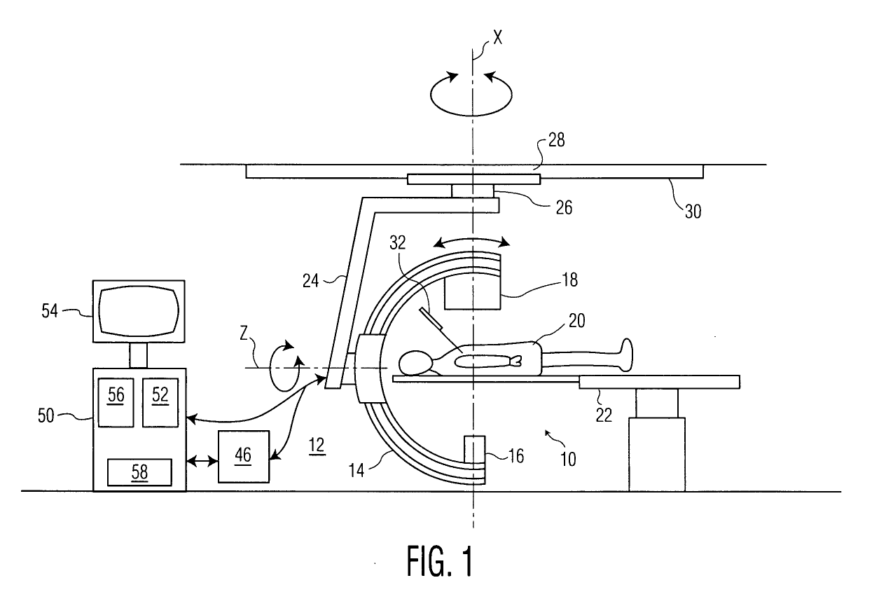

FIG. 1 depicts an X-ray imaging system in accordance with an exemplary embodiment of the invention;

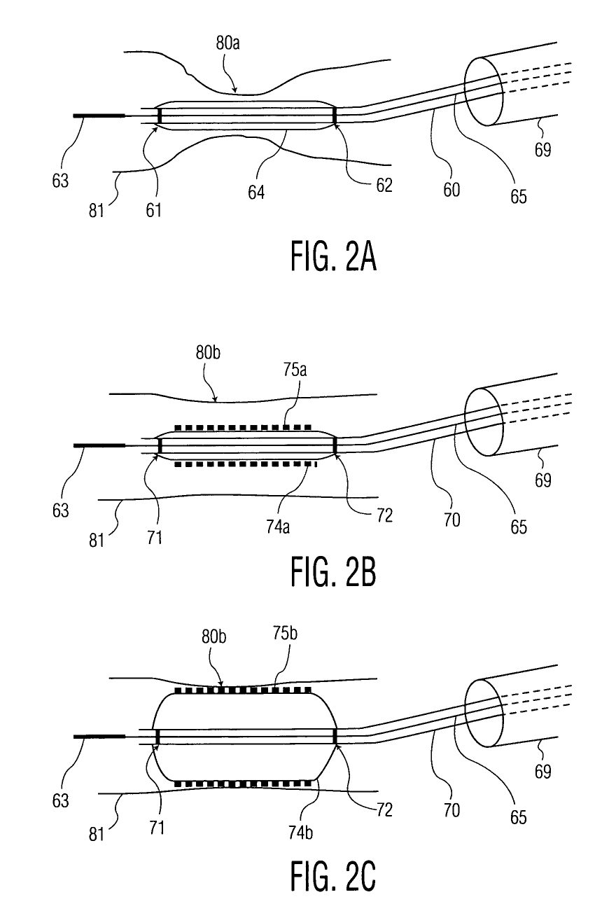

FIG. 2A-2C provide illustration of the intervention steps for angioplasty;

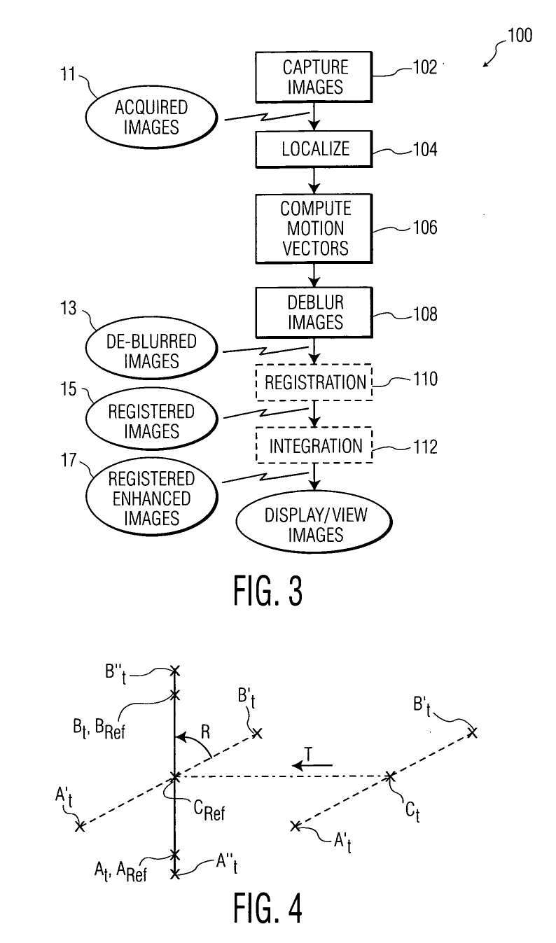

FIG. 3 depicts a block diagram depicting an example of the disclosed methodologies; and

FIG. 4 depicts image registration in accordance with an exemplary embodiment of the invention.

The disclosed embodiments relate to an imaging system, and to a computer executable image processing method that is used in the imaging system, for enhancing objects of interest in a sequence of noisy images and for displaying the sequence of enhanced images. The imaging system and method have means to acquire, process and display the images in near real time. The imaging system and the image processing method of the invention are described hereafter as a matter of example in an application to the medical field of cardiology. In such an application, the objects of interest are organs such as arteries and tools such as balloons or stents. These objects are observed during a medical intervention called angioplasty, in a sequence of X-ray fluoroscopic images called angiograms. The system and method may be applied to any other objects of interest than stents and vessels in other images than angiograms. The objects of interest may be moving with respect to the image reference, but not necessarily, and the background may be moving with respect to the object or to the image reference.

The embodiments described hereafter uniquely relate to an image processing system and an image processing method. In an exemplary embodiment the images are acquired, in this example, as a sequence of image projections during a stent implantation, which is a medical intervention performed under fluoroscopy, and which usually comprises several steps for enlarging an artery at the location of a lesion called a stenosis. In an exemplary embodiment, the tools/processes employed for conventional “stent boost” for enhancement of noisy fluoroscopic images are employed to detect marker positions in a set of image projections. From the subsequent marker positions in the projections and the frame rate, the speed and direction of the marker movement can be derived. These vectors are then employed to deconvolve the images for the motion blur that correspond to that motion and the used X-ray pulse width. Advantageously, an exemplary embodiment of the invention provides near real time, improved fluoroscopic images over existing fluoroscopy methods and systems with compensation for motion blur.

As set forth herein, the present disclosure advantageously permits and facilitates clear two dimensional (2D) imaging of a (cardiac) stent based on a number of 2D projections of that stent and its markers. Optionally, the procedure may be expanded and applied to three dimensional (3D), or four dimensional (4D) (commonly considered 3D with cardiac phase) imaging based on reconstructions from a number of 2D projections of that stent and its markers. By detecting the markers and thus the shift, rotation, and scaling of the stent in the different projections, compensation for the motion of the stent can be implemented. The compensation facilitates combining a number of the projections to yield a high resolution low noise image. Advantageously the disclosed invention further enhances existing images employing “stent boost”, by also correcting for motion blur. Motion blur occurs when the stent moves “fast” compared to the detector resolution/x-ray pulse length and stent wire thickness. Unfortunately, current imaging methodologies employing stent boost only correct for translation, rotation, and scaling and do not provide compensation for motion blur. For example, for current technology flat panel detectors, if the detector exhibits a resolution of 140 micron, the stent speed 10 cm/s, the pulse length 10 ms and the stent wire thickness is 100 micron, then the stent is blurred over 1 mm, which in this example equals 7 pixels. Unfortunately, magnification of the system (1.5 times, typically) makes the blur even worse (more than 10 pixels).

“Stent boost” is a method for improving the visualization and spatially enhancing of low-contrast structures such as stents in noisy images as disclosed in U.S. Patent Application Publication 2005/0002546 to Florent et al., hereinafter referred to as Florent, published Jan. 6, 2005, the contents of which are incorporated herein by reference in their entirety. This application describes a method and system that has means to process images in real time in order to be dynamically displayed during an intervention phase. Furthermore, Florent describes a system and method for enhancing low-contrast objects of interest, for minimizing noise and for fading the background in noisy images such as a sequence of medical fluoroscopic images. Generally, the methodology is targeted to angiograms representing vessels and stents as objects of interest, which present a low contrast, which may be moving on the background, but not necessarily, and which have previously been detected and localized.

“Stent boost” delivers the x-y coordinates of the X-ray markers on the stent for each X-ray 2D projection image. The motion/speed vectors of the markers corresponding to each image can be derived, because the time duration between images is also known. Thereafter, from these computed vectors and the known X-ray pulse shape, a spatial deconvolution kernel can be derived which is then employed to sharpen the image in the direction of the motion as indicated by the motion vectors.

Turning now to FIG. 1, a medical examination apparatus 10 is depicted in accordance with an exemplary embodiment of the invention. The system 10 includes a means for acquiring digital image data of a sequence of images 12, and is coupled to a medical viewing system 50, 54. The medical viewing system is generally used in the intervention room or near the intervention room for processing real time images. In an exemplary embodiment the imaging system is an X-ray device 12 with a C-arm 14 with an X-ray tube 16 arranged at a first end and an X-ray detector 18, for example an image intensifier, arranged at its other end. Such an X-ray device 12 is suitable for forming X-ray projection images 11 of a patient 20, arranged on a table 22, from different X-ray positions; to this end, the position of the C-arm 14 can be changed in various directions, the C-arm 14 is also optionally constructed so as to be rotatable about three axes in space, that is, X, Z as shown and Y (not shown). The C-arm 14 may be attached to the ceiling via a supporting device 24, a pivot 26 and a slide 28 which is displaceable in the horizontal direction in a rail system 30. The control of these motions for the acquisition of projections from different X-ray positions and of the data acquisition is performed by means of a control unit 50.

A medical instrument 32 including, but not limited to a probe, needle, catheter, guidewire, and the like, as well as combinations including at least one of the foregoing may be introduced into the patient 20 such as during a biopsy or an intervention treatment. The position of the medical instrument 32 relative to a three-dimensional image data set of the examination zone of the patient 20 may be acquired and measured with a position measurement system (not shown) and/or superimposed on the 3D/4D images reconstructed as described herein in accordance with an exemplary embodiment.

In addition, optionally an electrocardiogram (ECG) measuring system 34 is provided with the X-ray device 12 as part of the system 10. In an exemplary embodiment the ECG measuring system 34 is interfaced with the control unit 50. Preferably, the ECG of the patient 20 is measured and recorded during the X-ray data acquisition to facilitate determination of cardiac phase. In an exemplary embodiment, cardiac phase information is employed to partition and distinguish the X-ray projection image data 11. It will be appreciated that while an exemplary embodiment is described herein with reference to measurement of ECG to ascertain cardiac phase, other approaches are possible. For example, cardiac phase and/or projection data partitioning may be accomplished based on the X-ray data alone, other parameters, or additional sensed data.

The control unit 50 controls the X-ray device 12 and facilitates image capture and provides functions and processing to facilitate image processing and optional reconstruction. The control unit 50 receives the data acquired (including, but not limited to, X-ray images, position data, and the like) so as to be processed in an arithmetic unit 52. The arithmetic unit 52 is also controlled and interfaced with the control unit 50. Various images can be displayed on a monitor 54 in order to assist the physician during the intervention. The system provides processed image data to display and/or storage media 58. The storage media 58 may alternatively include external storage means. The system 10 may also include a keyboard and a mouse for operator input. Icons may be provided on the screen to be activated by mouse-clicks, or special pushbuttons may be provided on the system 10 to constitute control for the user to start, to control the duration or to stop the imaging or processing as needed.

In order to perform the prescribed functions and desired processing, as well as the computations therefor (e.g., the X-ray control, image reconstruction, and the like), the control unit 50, arithmetic unit 52, monitor 54, and optional reconstruction unit 56, and the like may include, but not be limited to, a processor(s), computer(s), memory, storage, register(s), timing, interrupt(s), communication interface(s), and input/output signal interfaces, and the like, as well as combinations comprising at least one of the foregoing. For example, control unit 50, arithmetic unit 52, monitor 54, and optional reconstruction unit 56, and the like may include signal interfaces to enable accurate sampling, conversion, acquisitions or generation of X-ray signals as needed to facilitate generation of X-ray projection images 11 and optionally reconstruction of 3D/4D images therefrom. Additional features of the control unit 50, arithmetic unit 52, monitor 54, and optional reconstruction unit 56, and the like, are thoroughly discussed herein.

The X-ray device 12 shown is suitable for forming a series of X-ray projection images 11 from different X-ray positions prior to and/or in the instance on an exemplary embodiment concurrent with an intervention. From the X-ray projection images 11 a motion vector is computed to facilitate implementation of the embodiments disclosed herein. Optionally, a three-dimensional image data set, three-dimensional reconstruction images, and if desired X-ray slice images therefrom may be generated as well. The projection images 11 acquired are applied to an arithmetic unit 52 which, in conformity with the method in accordance with an exemplary embodiment computes a motion vector corresponding to each image projection 11, and applies a deconvolution to deblur the image projections 11.

Optionally the image projection(s) 11 are also applied to a reconstruction unit 56 which forms a respective reconstruction image from the projections based on the motion compensation as disclosed at a later point herein. The resultant 3D image can be displayed on a monitor 54. Finally, three-dimensional image data set, three-dimensional reconstruction images, X-ray projection images compensated image projections, and the like may be saved and stored in a storage unit 58.

Turning now to FIGS. 2A and 3, to introduce a stent at a stenosis, the practitioner localizes the stenosis 80a in a patient's artery 81 as best as possible. A corresponding medical image is schematically illustrated by FIG. 2A. Then, the sequence of images 11 is captured as depicted at process block 102. The sequence of images 11 to be processed is acquired as several sub-sequences during the steps of the medical intervention, comprising:

a) A sub-sequence of medical images, schematically illustrated by FIG. 2A, which displays the introduction in the artery 81 through a catheter 69 of a thin guide-wire 65 that extends beyond the extremity of the catheter 69, and passes through the small lumen 80a of the artery at the location of the stenosis; the introduction of a first monorail 60, which is guided by the guide-wire 65 having a first balloon 64 wrapped around its extremity, without stent; and the positioning of the first balloon 64 at the location of the stenosis 80a using the balloon-markers 61, 62.

b) A sub-sequence of medical images, schematically illustrated by FIG. 2A and FIG. 2B, which displays the inflation of this first balloon 64 for expanding the narrow lumen 80a of the artery 81 at the location of the stenosis to become the enlarged portion 80b of the artery; then, the removal of the first balloon 64 with the first monorail 60.

c) A sub-sequence of medical images, schematically illustrated by FIG. 2B, which displays the introduction of a second monorail 70 with a second balloon 74a wrapped around its extremity, again using the catheter 69 and the thin guide-wire 65, with a stent 75a wrapped around the second balloon 74a; and the positioning of the second balloon with the stent at the location of the stenosis in the previously expanded lumen 80b of the artery 81 using the balloon-markers 71, 72. In a second way of performing the angioplasty, the clinician may skip steps a) and b) and directly introduce a unique balloon on a unique monorail, with the stent wrapped around it.

d) A sub-sequence of medical images, schematically illustrated by FIG. 2C, which displays the inflation of the second balloon 74a to become the inflated balloon 74b in order to expand the coil forming the stent 75a that becomes the expanded stent 75b embedded in the artery wall. In the second example, the unique balloon is directly expanded both to expand the artery and deploy the stent.

Then, considering the deployed stent 75b as a permanent implant, the sub-sequence of medical images, displays the removing of the second (or unique) balloon 74b, the second (or unique) monorail 70, the guide-wire 65 and catheter 69.

The medical intervention as described herein also called angioplasty is difficult to carry out because the image sub-sequences or the image sequences are formed of medical images 11 generally exhibiting poor contrast, where the guide-wire 65, balloon 74a, 74b, stent 75a, 75b and vessel walls 81 are not easily distinguishable on a noisy background. Furthermore, the image projections 11 are subjected to patient motions, including breathing and cardiac motions. According to an exemplary embodiment of the invention, the imaging system disclosed herein includes means not only for acquiring and displaying a sequence of images 11 during the intervention, but for processing and displaying images including compensation for motion over existing methodologies.

Turning now to FIG. 3, a block diagram depicting an exemplary embodiment of the invention is depicted. Similar to the processes for “stent boost” described in Florent, the methodology 100 initiates with an initialization as depicted at process 104 applied to the original captured 2D projection images 11 from 102 described above for extracting and localizing the object of interest, which is usually moving. Localization of the objects in the 2D projection images may be accomplished directly. However, as most objects are difficult to discern in X-ray fluoroscopy, they are preferably localized indirectly. Accordingly, in an exemplary embodiment of the invention, the objects are localized by first localizing related markers e.g., 61, 62, 71, and/or 72.

Continuing with FIG. 3 and referring to FIGS. 2A-2C as well, the initialization preferably includes accurately localizing the object of interest in the sequence of images. The object of interest are preferably localized indirectly by localizing first specific features such as the guide-wire tip 63 or the balloon-markers 61, 62 or 71, 72. The markers 61, 62 which are located at the extremity of the thin guide-wire 65, permits the determination of the position of the guide-wire 65 with respect to the stenosed zone 80a of the artery 81. The balloon-markers 61, 62, which are located on the monorail 60 at a given position with respect to the first balloon 64, permit determining the position of the first balloon 64 with respect to the stenosed zone 80a before expanding the first balloon 64 in the lumen of the artery. Likewise, the balloon-markers 71, 72, which are located on the monorail 70 at a given position with respect to the second balloon 74a, facilitate determination of the position of the second balloon 74a, with the stent 75a wrapped around it, before stent expansion and permits of finally checking the expanded stent 75b.

These specific features called tips 63 or markers 61, 62 or 71, 72 exhibit significantly higher contrast than the stent 75a, 75b or vessel walls 81, therefore they are readily extracted from the original images 11. However, the clinician may choose to select the tips 63 and markers 61, 62 or 71, 72 manually or to improve manually the detection of their coordinates. These tips 63 and markers 61, 62 or 71, 72 have a specific, easily recognizable shape, and are made of a material highly contrasted in the images. Hence, they are easy to extract. It is to be noted that these specific features do not pertain to the poorly contrasted stent 75a, 75b or the vessel walls 80a, 80b, which are the objects that are actually finally of interest for the practitioner yet far less discernable in the noisy original images 11. The guide-wire tip 63 pertains neither to the artery walls 81 nor to the stent 75a, since it pertains to the guide-wire 65. Also, the balloon-markers 61, 62 or 71, 72 pertain neither to the vessel walls 81 nor to the stent 75a since they pertain to the monorail 60 or 70. The location of the balloons 64, 74a, 74b, may be accurately derived since the balloon-markers 61, 62 or 71, 72 have a specific location with respect to the balloons 64, 74a. Also, the stents 75a, 75b are accurately localized, since the stents 75a, 75b have a specific location with respect to the balloon-markers 71, 72 though the stents 75a, 75b are not attached to the markers 71, 72. Once the markers 61, 62 or 71, 72 of an object of interest has been extracted, a velocity vector for the object of interest in a given image is ascertained, preferably based on the marker locations.

In an exemplary embodiment of the invention, based on the series of 2D image projections 11 and the position variation of the markers 61, 62, 71, and/or 72 between successive 2D projection images or a plurality of 2D projection images, a motion or velocity vector is computed as depicted at process block 106 associated with each 2D projection image. The motion vector being based on the change in position of the markers 61, 62, 71, and/or 72 over the duration of the imaging between frames. The velocity vector is preferably, but not necessarily, computed based upon immediately successive 2D projection images 11 to provide the best possible resolution for the computation of the motion vector(s). However, employing a subset of the images may be possible.

Continuing with FIG. 3, at process block 108, the methodology continues with deblurring the images by applying a deconvolution with the motion vector to each of the images 11. A spatial deconvolution kernel can be derived which is used to sharpen the particular raw/original image 11 in the direction of the motion associated with that image based on the motion vector. This results in a sequence of motion compensated deblurred images 13. In another exemplary embodiment the deconvolution process employs a “blind deconvolution.” Blind deconvolution is a technique which permits recovery of the target object from a “blurred” image in the presence or a poorly determined or unknown blurring kernel. Regular linear and non-linear deconvolution techniques require a known kernel. Blind deconvolution techniques employ either conjugate gradient or maximum-likelihood algorithms. Blind deconvolution does not require a known kernel, but preferably is a recursive algorithm that employs the motion vector and the shape of the X-ray pulse information as a good first estimate of the blurring kernel. The blind deconvolution then recursively estimates improvements to the kernel to enhance the deblurring of the raw image.

Continuing with FIG. 3, the resultant of the deconvolution is a series of compensated deblurred images for each of the associated motion vectors. This series of compensated images 13 may then be employed in the subsequent registration and integration processes previously associated with the abovementioned stent boost techniques as described in Florent. Advantageously, the motion compensated images 13 provide an enhanced “starting point” for the noise reduction techniques of Florent as opposed to previous methodology where the raw image projection data 11 was employed.

Continuing with FIG. 3 and referring now to FIG. 4, at process block 10 the deblurred images 13 of the moving object of interest are registered with respect to an image reference. The registration may include a subset of the images, particularly if it is known that such a grouping of images can be associated with a particular motion or phase of motion. The registration process converts the deblurred images 13 to a common reference to further facilitate the compensation described herein. The registration process 110 yields a registered sequence of images 15 for later processing.

In an exemplary embodiment to initiate the registration process 110, two markers A_{Ref}, B_{Ref} have been detected in an image of the sequence, called a reference image, which may be the image at starting time. The markers A_{Ref}, B_{Ref} may be selected by automatic means. Then, the registration, using the marker location information A_{Ref}, B_{Ref} in the reference image and corresponding extracted markers A′t, B′t in a current image of the deblurred image sequence 13, are operated for automatically registering the current image on the reference image. This operation is performed by matching the markers of the current image to the corresponding markers of the reference image, comprising possible geometrical operations including: a translation T to match a centroid Cₜ of the segment A′ₜ-B′ₜ of the current image with a centroid C_{Ref} of the segment A_{Ref}-B_{Ref} of the reference image; a rotation R to match the direction of the segment A′ₜ-B′ₜ of the current image with the direction of the segment A_{Ref}-B_{Ref} of the reference image, resulting in a segment A″ₜ-B″ₜ; and a dilation Δ for matching the length of the resulting segment A″ₜ-B″ₜ with the length of the segment A_{Ref}-B_{Ref} of the reference image, resulting in the segment Aₜ-Bₜ. Such operations of translation T, rotation R and dilation Δ are defined between the current image at a current instant t of the sequence and an image of reference, resulting in the registration of the whole sequence. This operation of registration is not necessarily performed on all the points of the deblurred images 13. Zones of interest comprising the markers may be delimited.

The registration minimizes the effect of respective movements of the objects of interest, such as vessels 81, guide-wire 65, balloons 64, 74a and stent 75a, 75b, with respect to a predetermined image reference. Preferably, two markers 61, 62, 71, and/or 72, or more, are used for better registration. Advantageously, the registration operation 110 also facilitates zooming in on the object of interest e.g., the stenosis or stent, without the object evading from the frame of the particular image.

Returning to FIG. 3 and the process 100, as depicted at process block 112, a temporal integration technique is performed on at least two of the images from the registered images 15. This technique enhances the object of interest in the images 15 because the object has previously been registered with respect to the reference of the images. The first number of images for the first temporal integration is chosen according to a compromise to avoid blurring the object having residual motion and to cause the blurring of the background. The temporal integration, 112 also denoted by TI₁ integrates object pixels that correspond to same object pixels in successive images, so that their intensities are increased. Likewise, the temporal integration 112 also integrates background pixels that do not correspond to the same background pixels in the successive images, so that their intensities are decreased. In other words, the temporal integration provides motion correction to the object of interest in the registered images 15, yet not to the background. After registration, the background still moves with respect to the reference of the images, the temporal integration provides sharp detail enhancement of the object of interest, which are substantially in time concordance, while the details of the background which are not in time concordance, are further blurred. In an exemplary embodiment, the temporal integration may include a process for averaging the pixel intensities, at each pixel location in the reference image, and on two or more images. In another example, the temporal integration includes a recursive filter, which performs a weighted average of pixel intensity on succeeding images. That is, a recursive filter for combining the current image at an instant t, where the intensities are denoted by X(t), to the image processed at a previous instant (t−1), where the intensities are denoted by Y(t−1), using a weighting coefficient .beta., according to a formula giving the intensities of the integrated current image:

Y(t)=Y(t−1)+.beta.[X(t)−Y(t−1)] [1]

Using this last technique, the images are progressively improved as the sequence proceeds. This operation yields an intermediate sequence 17 of registered enhanced images with a blurred background, further used for sharp detail enhancement. Further enhancement of the images is possible using the optimization techniques described in Florent.

Advantageously, now that the objects are registered in the images and that the details are enhanced, the operator may readily observe the balloon 64, 74a and stent 75a, 75b positioning. Moreover, an operator may easily zoom on details of an object with the advantage that the object does not move out of the viewing frame of the image.

In the present example as applied to cardiology, the user during a medical intervention has the possibility to intervene during the image processing steps, for example while not moving the intervention tool or tools. First of all, the user might choose a region of interest in the images. Besides, the user has at his disposal a control to activate and control the image processing, the duration of the image processing operation, and to end the image processing operation. In particular, the user may choose that the final processed images are compensated for the registration or not, depending on whether the motion of objects is of importance for the diagnosis or not.

It should also be appreciated that due to the advantages and enhancements of the disclosed embodiments, it should no longer be necessary for the practitioner to introduce a contrast agent in the balloon 64, 74a for inflating the balloon 64, 74a in the stent 75a, 75b. With the described embodiments, the balloon 64, 74a is better visualized together with the stent 75a, 75b and markers 61, 62, 71, and/or 72 without the need for the contrast agent. This property is also particularly useful when it is necessary to visualize a sequence of images of an intervention comprising the introduction and positioning of two stents 75a, 75b side by side in the same artery 81. The first stent 75a, 75b is clearly visualized after its deployment. Then the second stent 75a, 75b is visualized and located by the detection of its markers 61, 62, 71, and/or 72. These objects are further registered and enhanced, which permits the practitioner of visualizing the second balloon during inflation and the stent 75a, 75b during deployment, in dynamic instead of in static as was the case when contrast agent was necessary to localize the balloon 64, 74a. Normally, the practitioner may position the two stents 75a, 75b very near to one another when necessary because their visualization is excellent.

It is noteworthy to appreciate that the exemplary embodiments disclosed herein further permit improvement of the images of the sub-sequence that are acquired as described above in step c), in reference to FIG. 2C, in such a way that the medical intervention steps may be simplified. In fact, for deploying the balloon 64, 74a in step c), starting from the shape 74a to yield the shape 74b, the practitioner must introduce an inflation product into the balloon 64, 74a. In existing applications, the practitioner generally uses an inflation product that includes a large amount of a contrast agent in order to be able to visualize the balloon 64, 74a. This contrast agent has for an effect to render the balloon 64, 74a and stent 75a, 75b as a sole dark object in the images of the sub-sequence. When using such a contrast agent, the balloon 64, 74a and stent 75a, 75b are not distinguishable from one another during the balloon inflation and stent deployment. The practitioner must wait until the removing of the darkened balloon 64, 74a for at least having a view of the deployed stent alone, and it is only a static view.

Conversely, with the exemplary embodiments described herein the use of contrast agent in the inflation product may be eliminated, or substantially reduced. As a result, the balloon 64, 74a now remains transparent, thus the practitioner may dynamically visualize the inflation of the balloon 64, 74a and stent deployment in all the images of the sequence.

The present invention may be utilized for various types of applications of 2D, 3D/4D imaging. A preferred embodiment of the invention, by way of illustration is described herein as it may be applied to X-ray imaging as utilized for electro-physiology interventions and placement of stents. While a preferred embodiment is shown and described by illustration and reference to X-ray imaging and interventions, it will be appreciated by those skilled in the art that the invention is not limited to the X-ray imaging or interventions alone, and may be applied to imaging systems and applications. Moreover, it will be appreciated that the application disclosed herein is not limited to interventions alone but is in fact, applicable to any application, in general, where 2D, 3D/4D imaging is desired.

The system and methodology described in the numerous embodiments hereinbefore provide a system and method for enhancing noisy structures during an intervention. In addition, the disclosed invention may be embodied in the form of computer-implemented processes and apparatuses for practicing those processes. The present invention can also be embodied in the form of computer program code containing instructions embodied in tangible media 58, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or as data signal transmitted whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

It will be appreciated that the use of “first” and “second” or other similar nomenclature for denoting similar items is not intended to specify or imply any particular order unless otherwise specifically stated. Likewise the use of “a” or “an” or other similar nomenclature is intended to mean “one or more” unless otherwise specifically stated.

It will further be appreciated that while particular sensors and nomenclature are enumerated to describe an exemplary embodiment, such sensors are described for illustration only and are not limiting. Numerous variations, substitutes, and equivalents will be apparent to those contemplating the disclosure herein. It will be evident that there exist numerous numerical methodologies in the art for implementation of mathematical functions, in particular as referenced here, line integrals, filters, taking maximums, and summations. While many possible implementations exist, a particular method of implementation as employed to illustrate the exemplary embodiments should not be considered limiting.

While the invention has been described with reference to a exemplary embodiments thereof, it will be understood by those skilled in the art that the present disclosure is not limited to such exemplary embodiments and that various changes may be made and equivalents may be substituted for elements thereof without departing from the scope of the invention. In addition, a variety of modifications enhancements and/or variations may be made to adapt a particular situation or material to the teachings of the invention without departing from the essential spirit or scope thereof. Therefore, it is intended that the invention not be limited to the particular embodiment disclosed as the best mode contemplated for carrying out this invention, but that the invention will include all embodiments falling within the scope of the appended claims.

1. A method for enhancing objects of interest in a sequence of noisy images (11), the method comprising:
acquiring the sequence of images (11);
extracting features (61), (62), (71), (72) related to an object of interest on a background in images of the sequence (11) having an image reference;
computing a motion vector corresponding to motion of the object of interest associated with at least two images of the sequence (11);
deblurring each image of the sequence (11) based on its corresponding motion vector to form a deblurred sequence of images (13);
registering said features (61), (62), (71), (72) related to the object of interest in the deblurred sequence of images (13) with respect to the image reference, yielding a registered sequence of images (15); and
integrating with a temporal integration both the object of interest and the background over at least two registered images of the registered sequence of images (15).

2. The method of claim 1 wherein said extracting comprises detecting markers (61), (62), (71), (72) in at least two images.

3. The method of claim 1 wherein said motion vectors correspond to the motion of markers (61), (62), (71), (72) in two successive images per time frame of said acquiring the sequence of images (11).

4. The method of claim 1 wherein said deblurring is a deconvolution.

5. The method of claim 1 wherein said deblurring is a blind deconvolution.

6. The method of claim 1 further including displaying any of said sequence of images (11), said deblurred sequence of images (13), a resultant of said registering (15), or a resultant of said integrating.

7. The method of claim 1, wherein said registering further includes zooming with respect to a registered object of interest.

8. The method of claim 1 wherein said integrating provides an increase in intensity of the object of interest while blurring and thereby fading background and the noise.

9. The method of claim 1, further including dynamically displaying a sequence of medical images of a medical intervention that comprises moving and/or positioning a tool called balloon (64), (74a), in an artery (81), said balloon (64), (74a) and artery being considered as objects of interest, and said balloon (64), (74a) being carried by a support called monorail (60, 70), to which at least two localizing features called balloon-markers (61,62, 71,72) are attached and located in correspondence with the extremities of the balloon (64), (74a), wherein: said extracting includes extracting the balloon-markers (61), (62), (71), (72) considered as features related to the objects of interest, which balloon-markers (64), (74a) pertain neither to the balloon (64), (74a) nor to the artery (81); said computing motion vectors correspond to the motion of the markers (61), (62), (71), (72) in two successive images per time frame of said acquiring the sequence of images (11); said deblurring based on said motion vector corresponding to motion of said markers (61), (62), (71), (72); said registering includes registering the balloon-markers (61), (62), (71), (72) and the related balloon (64), (74a) and artery (81) in the images (13); generating images of enhanced balloon and artery by integrating.

10. The method of claims 9 further including: dynamically displaying the images during the medical intervention for the user to visualized images of the balloon (64), (74a) during its positioning in the artery (81), at a specific location of a portion of the artery (81), with respect to the balloon-marker extracted location.

11. The method of claim 8, further including dynamically displaying and visualizing images of the stent deployment during a stage of balloon inflation with an inflation product without or with substantially little contrast agent.

12. The method of claim 9, wherein said registering further comprises:
selecting an image of the sequence (13) called reference image, and at least a marker called reference marker in the reference image related to an object of interest; and
employing the marker location information in the reference image and in a current image of the sequence (13), for registering the marker and the related object of interest of the current image by matching the marker of the current image to the reference marker of the reference image.

13. A method for enhancing objects of interest in a sequence of noisy images, the method comprising:
acquiring the sequence of images (11);
extracting features (61), (62), (71), (72) related to an object of interest on a background in images of the sequence (11) having an image reference;
computing a motion vector corresponding to motion of the object of interest associated with at least two images of the sequence (11); and
deblurring each image of the sequence based on its corresponding motion vector to form a deblurred sequence of images (13).

14. A system for enhancing objects of interest in a sequence of noisy images, the system comprising:
and imaging system (12) for acquiring the sequence of images (11);
a plurality of markers (61), (62), (71), (72) placed in proximity to an object of interest, said markers discernible in the sequence of images (11);
a processor (50) in operable communication with said imaging system (12), said processor (50) configured to:
compute a motion vector corresponding to motion of the object of interest associated with at least two images of the sequence;
deblurr each image of the sequence (11) based on its corresponding motion vector to form a deblurred sequence of images (13);
register said features (61), (62), (71), (72) related to the object of interest in the deblurred sequence of images (13) with respect to the image reference, yielding a registered sequence of images (15); and
integrate with a temporal integration both the object of interest and background over at least two registered images of the registered sequence of images (15).

15. The system of claim 14 wherein said motion vectors correspond to the motion of markers (61), (62), (71), (72) in two successive images per time frame of said acquiring the sequence of images (11).

16. The system of claim 14 wherein said deblurring is at least one of a deconvolution or a blind deconvolution.

17. The system of claim 14 further including a display device (54) for displaying any of said sequence of images (11), said deblurred sequence of images (13), a resultant of said registering (15), or a resultant of said integrating (17).

18. The system of claim 14 further including a control device for controlling said processor (50) or said imaging system (12).

19. A medical examination imaging apparatus for enhancing objects of interest in a sequence of noisy images comprising:
means (12) for acquiring the sequence of images (11);
means for extracting features (61), (62), (71), (72) related to an object of interest on a background in images of the sequence (11) having an image reference;
means for computing a motion vector corresponding to motion of the object of interest associated with at least two images of the sequence (11);
means for deblurring each image of the sequence based on its corresponding motion vector to form a deblurred sequence of images (13);
means for registering said features related to the object of interest in the deblurred sequence of images (13) with respect to the image reference, yielding a registered sequence of images (15); and
means for integrating with a temporal integration both the object of interest and the background over at least two registered images of the registered sequence of images (13).

20. A storage medium (58) encoded with a machine readable computer program code, the code including instructions for causing a computer to implement a method for enhancing objects of interest in a sequence of noisy images (11), the method comprising:
acquiring the sequence of images (11);
extracting features related to an object of interest on a background in images of the sequence (11) having an image reference;
computing a motion vector corresponding to motion of the object of interest associated with at least two images of the sequence (11);
deblurring each image of the sequence based on its corresponding motion vector to form a deblurred sequence of images (13);
registering said features related to the object of interest in the deblurred sequence of images with respect to the image reference, yielding a registered sequence of images (15); and
integrating with a temporal integration both the object of interest and the background over at least two registered images of the registered sequence of images (15).

21. A computer data signal, said computer data signal comprising instructions for causing a computer to implement a method for enhancing objects of interest in a sequence of noisy images (11), the method comprising:
acquiring the sequence of images (11);
extracting features related to an object of interest on a background in images of the sequence (11) having an image reference;
computing a motion vector corresponding to motion of the object of interest associated with at least two images of the sequence (11);
deblurring each image of the sequence (11) based on its corresponding motion vector to form a deblurred sequence of images (13);
registering said features related to the object of interest in the deblurred sequence of images (13) with respect to the image reference, yielding a registered sequence of images (13); and
integrating with a temporal integration both the object of interest and the background over at least two registered images of the registered sequence of images (13).
